(19) United States
(12) Patent Application Publication
(10) Pub. No.: US 2017/0154263 A1
(43) Pub. Date: Jun. 1, 2017

(54) METHOD FOR PLACING ROOMS IN A BUILDING SYSTEM

(71) Applicant: Aditazz, Inc., Brisbane, CA (US)

(72) Inventors: ZACHARY DERETSKY, Belmont, CA (US); Alexander Khainson, Morgan Hill, CA (US); Maxim Samsonov, St. Petersburg (RU); Timur Gamerov, Krasnodar (RU)

(73) Assignee: Aditazz, Inc., Brisbane, CA (US)

(21) Appl. No.: 14/954,801

(22) Filed: Nov. 30, 2015

(51) Int. Cl. G06N 3/12; G06F 17/50

(52) U.S. Cl. CPC G06N 3/126; G06F 17/5004

(57) ABSTRACT

In an embodiment, a computer-implemented method for realizing room placement of a building system is disclosed. In the embodiment, the method involves generating a pool of room chromosomes by applying a genetic algorithm, wherein a room chromosome corresponds to a placement of a set of rooms in a building system, selecting a room chromosome with a desired fitness value from the pool of room chromosomes, the fitness value determined by applying a fitness function to at least one room chromosome in the pool, and graphically displaying a placement of rooms in a building system according to the selected room chromosome.

### BACKGROUND

Buildings are an integral part of everyday life. The process of planning, designing, and constructing buildings has evolved over several thousands of years. Today, the steps followed to physically realize modern buildings are very complicated and require a high degree of skilled labor that can span several different disciplines. This complexity poses a huge challenge in terms of time, money, and other resources expended in order to build a viable facility that can be used to deliver the intended services in an efficient and profitable way.

### SUMMARY

In an embodiment, a computer-implemented method for realizing room placement of a building system is disclosed. In the embodiment, the method involves generating a pool of room chromosomes by applying a genetic algorithm, wherein a room chromosome corresponds to a placement of a set of rooms in a building system, selecting a room chromosome with a desired fitness value from the pool of room chromosomes, the fitness value determined by applying a fitness function to at least one room chromosome in the pool, and graphically displaying a placement of rooms in a building system according to the selected room chromosome.

In another embodiment, generating the pool of room chromosomes includes generating an initial number of room chromosomes using a constraint-ratio heuristic and adding additional room chromosomes to the pool of room chromosomes by generating an additional room chromosome by applying the genetic algorithm to the pool of room chromosomes and adding the generated additional room chromosome to the pool of room chromosomes.

In another embodiment, the desired fitness value is the lowest fitness value calculated by a fitness function for a room chromosome in the pool of room chromosomes.

In another embodiment, generating an initial room chromosome involves forming an array of legal billets, each billet corresponding to a room to be placed in a department.

In another embodiment, legal billets are determined by orienting the department in a floor plan grid that is aligned with a structural grid of the building to divide the department into agents, the department indicating pathways, structural components, and boundaries, indexing agents along the sides of pathways in the department to create billets, for each room to be placed within the department, determining if a room can be placed on each billet, and for each room, recording billets on which the room can be placed as legal billets.

In another embodiment, generating an initial room chromosome in a pool of room chromosomes involves selecting a legal billet for each room to be placed within the department using a constraint-ratio heuristic function, the constraint-ratio heuristic function configured to take capacity constraints into account.

In another embodiment, applying the genetic algorithm to the pool of room chromosomes involves applying crossover and mutation heuristics to generate additional room chromosomes.

In another embodiment, the genetic algorithm is repeatedly applied until a fitness value less than a user-defined value is calculated for a room chromosome in the pool of room chromosomes.

In another embodiment, the genetic algorithm is repeatedly applied a user-defined number of times.

In another embodiment, applying crossover involves using binary tournament selection by randomly selecting two distinct parent room chromosomes from the pool of room chromosomes, selecting a first portion of billets in the first parent room chromosome, selecting a second portion of billets in the second parent room chromosome, and generating a third room chromosome by combining the first portion with the second portion of billets, wherein the combination of the first portion with the second portion includes billets for every room to be placed.

In another embodiment, applying mutation heuristics involves applying the Martello-Toth heuristic for mutation to a room chromosome.

In another embodiment, applying mutation heuristics to a room chromosome involves releasing a plurality of rooms from their location within a room chromosome, determining a measure of desirability for the placement of each released room in each of the openings from which the rooms were released, placing the released room with the greatest difference between its best measure of desirability and its second best measure of desirability in the opening corresponding to its best measure of desirability, wherein the closer a measure of desirability is to zero the better the measure is, and placing the remaining released rooms in the remaining openings such that the fitness value of the room chromosome is the closest fitness value to the desired fitness value possible for the room chromosome.

In another embodiment, a measure of desirability is determined by calculating a value by which the placement would impact the fitness value for the room chromosome.

In another embodiment, the fitness function is an integer function evaluated for several components, the components including a constraint cost, a cluster cost, a violation cost, an overlap cost, and a capacity excess cost.

In another embodiment, the fitness function F(x) for j rooms is calculated by:

$$F ( x ) = {\sum }_{i < j} {C}_{ij} + {a}_{1} \sum {C}_{i} + {a}_{2} \sum {V}_{i} + {a}_{3} \sum {O}_{i} + {a}_{4} \sum {e}_{i}$$

wherein i is a billet index, Cᵢⱼ is the constraint cost, Cᵢ is the cluster cost, Vᵢ is the violation cost, Oᵢ is the overlap cost, eᵢ is the capacity excess cost, and a is the weight for each cost.

In another embodiment, the constraint cost is determined by the relative distance between rooms within a department.

In another embodiment, the cluster cost is determined by the proximity of rooms to each other.

In another embodiment, the violation cost is determined by the number of user-defined constraints violated by a room chromosome.

In another embodiment, the overlap cost is determined by the number of agent overlaps in a room chromosome.

In another embodiment, the capacity excess cost is determined by the difference between the total sum of room sizes placed along a ruler and the capacity of the ruler.

In another embodiment, the constraint cost is determined by the relative distance between rooms within a department, the cluster cost is determined by the proximity of rooms to each other, the violation cost is determined by the number of user-defined constraints violated by a room chromosome, the overlap cost is determined by the number of agent overlaps in a room chromosome, and the capacity excess cost is determined by the difference between the total sum of room sizes placed along a ruler and the capacity of the ruler.

In a second embodiment, a computer-implemented method for placing rooms in a building system, the method involves generating a pool of room chromosomes by generating an initial number of room chromosomes using a constraint-ratio heuristic and adding additional room chromosomes to the pool of room chromosomes by generating an additional room chromosome by applying a genetic algorithm to the pool of room chromosomes by applying crossover and mutation heuristics, and adding the generated additional room chromosome to the pool of room chromosomes, and selecting a room chromosome with a desired fitness value from the pool of room chromosomes, the fitness value determined by applying a fitness function to at least one room chromosome in the pool, and graphically displaying a placement of rooms in a building system according to the selected room chromosome.

Other aspects and advantages of embodiments of the present invention will become apparent from the following detailed description taken in conjunction with the accompanying drawings.

### BRIEF DESCRIPTION OF THE DRAWINGS

FIG. 1 illustrates an embodiment of a floor plan of a hospital floor.

FIG. 2 illustrates a floor plan of a department oriented within a floor plan grid in accordance with an embodiment of the invention.

FIG. 3 illustrates billets in accordance with an embodiment of the invention.

FIG. 4 depicts a table of legal billets for rooms to be placed in accordance with an embodiment of the invention.

FIG. 5 illustrates a room chromosome for the placement of Room A, Room B, Room C₁, Room C₂, Room D and Room E within a department

FIG. 6 illustrates a second room chromosome generated in accordance with an embodiment of the invention.

FIG. 7 illustrates a constraint cost table for an attraction constraint.

FIG. 8A illustrates a minimum spanning tree.

FIG. 8B illustrates a second minimum spanning tree.

FIG. 9 illustrates the generation of a new room chromosome using crossover in accordance with an embodiment of the invention.

FIGS. 10A-10D illustrate an example of the mutation process.

FIG. 11 illustrates a placement of rooms within a department of a hospital in accordance with a room chromosome.

FIG. 12 depicts a block diagram of a building realization platform (BRP).

FIG. 13 is a flow chart diagram of a computer-implemented method for realizing room placement of a building system in accordance with an embodiment of the invention.

FIG. 14 is a flow chart diagram of a technique for applying crossover in accordance with an embodiment of the invention.

FIG. 15 is a flow chart diagram of a technique for applying mutation heuristics in accordance with an embodiment of the invention.

FIG. 16 is a block diagram of computer in which the building realization platform can run.

Throughout the description, similar reference numbers may be used to identify similar elements.

### DETAILED DESCRIPTION

It will be readily understood that the components of the embodiments as generally described herein and illustrated in the appended figures could be arranged and designed in a wide variety of different configurations. Thus, the following more detailed description of various embodiments, as represented in the figures, is not intended to limit the scope of the present disclosure, but is merely representative of various embodiments. While the various aspects of the embodiments are presented in drawings, the drawings are not necessarily drawn to scale unless specifically indicated.

The present invention may be embodied in other specific forms without departing from its spirit or essential characteristics. The described embodiments are to be considered in all respects only as illustrative and not restrictive. The scope of the invention is, therefore, indicated by the appended claims rather than by this detailed description. All changes which come within the meaning and range of equivalency of the claims are to be embraced within their scope.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussions of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize, in light of the description herein, that the invention can be practiced without one or more of the specific features or advantages of a particular embodiment. In other instances, additional features and advantages may be recognized in certain embodiments that may not be present in all embodiments of the invention.

Reference throughout this specification to “one embodiment,” “an embodiment,” or similar language means that a particular feature, structure, or characteristic described in connection with the indicated embodiment is included in at least one embodiment of the present invention. Thus, the phrases “in one embodiment,” “in an embodiment,” and similar language throughout this specification may, but do not necessarily, all refer to the same embodiment.

Practices of automating and adapting work flows can be applied to the realization of modern buildings. For example, automating and adapting work flows can be applied to the placement of rooms within a building system. The placement of rooms within a building system can be described as a combinatorial optimization problem (e.g., a knapsack problem) in which a solution seeks to optimize the placement of rooms within a building without violating physical limitations of the building system. For example, in a large building system (e.g., 200+ rooms) each room cannot share a common wall with every other room despite the optimization provided by common walls (e.g., no distance between rooms with a common wall). Rather, a solution to the placement of rooms seeks to determine, for example, which rooms should share a common wall to minimize the average daily travel by individuals using the building system. In a large building system with multiple rooms and pathways, the placement of rooms can be a complex and labor-intensive task.

In accordance with an embodiment of the invention, genetic algorithms are used to solve the placement of rooms within a building system. In order to use genetic algorithms, floor plans have been adapted to form chromosomes that can be mutated and altered by the genetic algorithm. In an embodiment, a computer-implemented method for placing rooms in a building system involves generating a pool of room chromosomes by applying a genetic algorithm, wherein a room chromosome corresponds to a placement of a set of rooms in a building system, selecting a room chromosome with a desired fitness value from the pool of room chromosomes, the fitness value determined by applying a fitness function to at least one room chromosome in the pool, and graphically displaying a placement of rooms in a building system according to the selected room chromosome. In an embodiment, the desired fitness value is the lowest fitness value calculated for a room chromosome in the pool of room chromosomes.

While the technique described above for realizing room placement can be applied to many types of modern buildings, the technique will be described below with reference to realizing room placement of a building system within which healthcare services will be provided (e.g., a hospital).

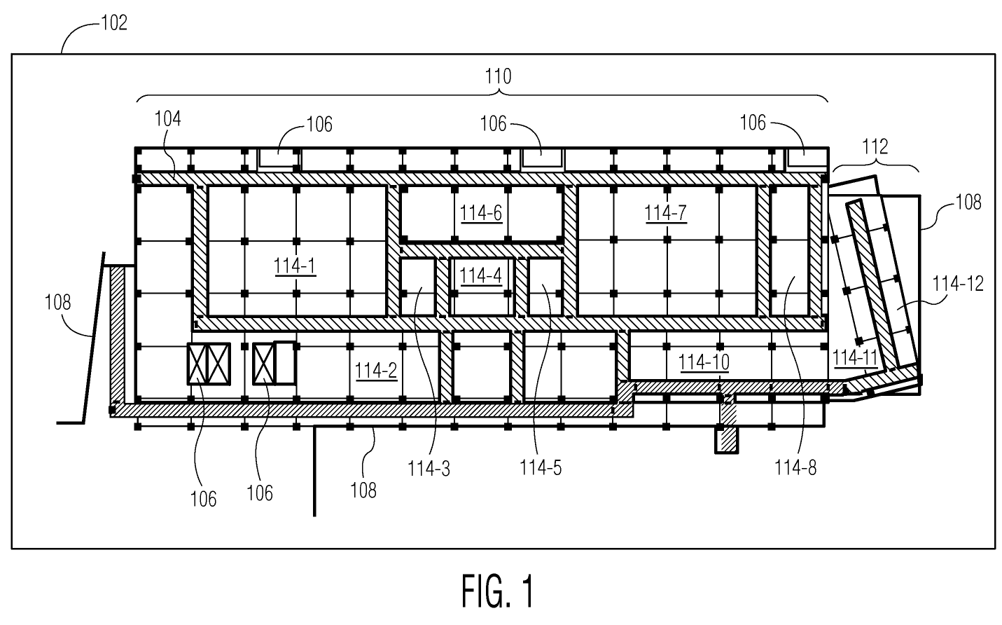

FIG. 1 illustrates an embodiment of a floor plan 102 of a hospital floor. As illustrated, the floor plan includes two departments 110, 112. Each department includes pathways 104, structural components (e.g., columns, elevator shafts, stairwells, walls, etc.) 106, and boundaries 108. The departments are divided into one or more zones (not shown) that can span one or more “wells” (e.g., areas bounded by pathways) 114-1-114-12. In an embodiment, rooms are placed within the wells along the pathways. In other embodiments, other configurations and features can be included or excluded from a floor plan (e.g., departments may not be divided by zones).

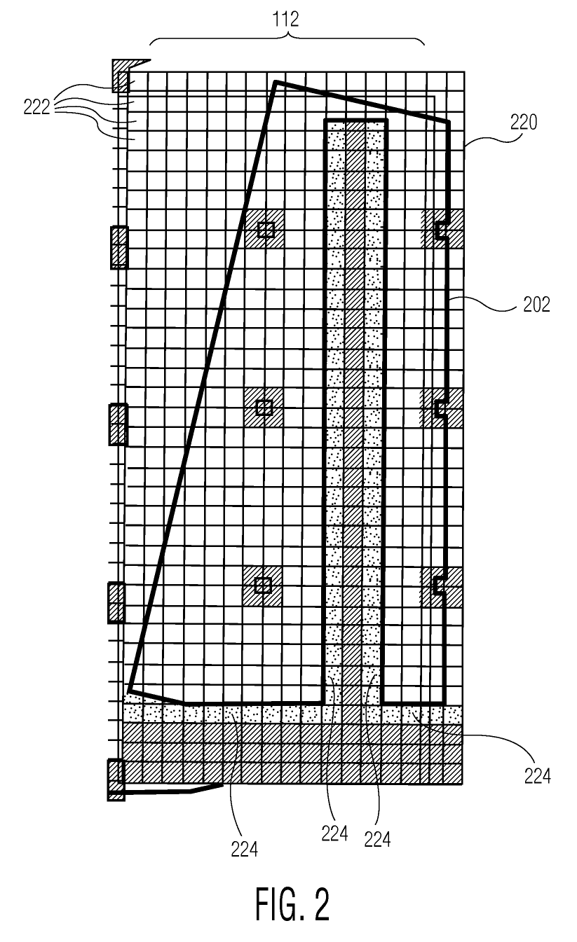

In an embodiment, a number of several room types are selected to be placed in a department based on the department type. For example, department 110 in FIG. 1 is an oncology department and includes 3 administrator conference rooms, 22 administrator/doctor offices, 2 client support utility rooms, 16 client support workstations, 2 janitorial rooms, 1 reception room, 8 stretcher storage rooms, 4 storage rooms, 8 bathrooms, 6 linear accelerator treatment rooms, 2 brachytherapy treatment rooms, and 6 waiting rooms. In order to place rooms along pathways within a department, a department is oriented such a structural grid of the department is aligned with a floor plan grid. In an embodiment, a structural grid of a department is a part of a structural grid of a building that indicates pathways and other structural components within a building (e.g., columns or stairs). Thus, aligning the structural grid of the department with a floor plan grid involves aligning pathways in the department vertically or horizontally within the floor plan grid. FIG. 2 illustrates a floor plan 202 of department 112 of FIG. 1 oriented within a floor plan grid 220 in accordance with an embodiment of the invention. The cells of the floor plan grid are referred to as “agents” 222 (e.g., small squares approximately 10 centimeter long on each side) and can be configured to indicate if the space of the floor plan corresponding to the agent is unoccupied, blocked, inside a department, outside of a department, inside of floor plan boundaries, or outside of floor plan boundaries (e.g., by color coding or other visual indication techniques). In an embodiment, rooms can be defined as having an x-step (e.g., a number of agents spanned by the room in the x-direction, the number of agents equaling a measured distance or range of measured distance), a y-step (e.g., a number of agents spanned by the room in the y-direction, the number of agents equaling a measured distance or range of measured distance). In an embodiment, agents along the edges of a well or along the sides of a pathway in a zone can be referred to as “rulers” 224 and rooms can be placed along the rulers. In an embodiment, a ruler can be defined as an array of agents (e.g., as a ruler object in an object-oriented language.)

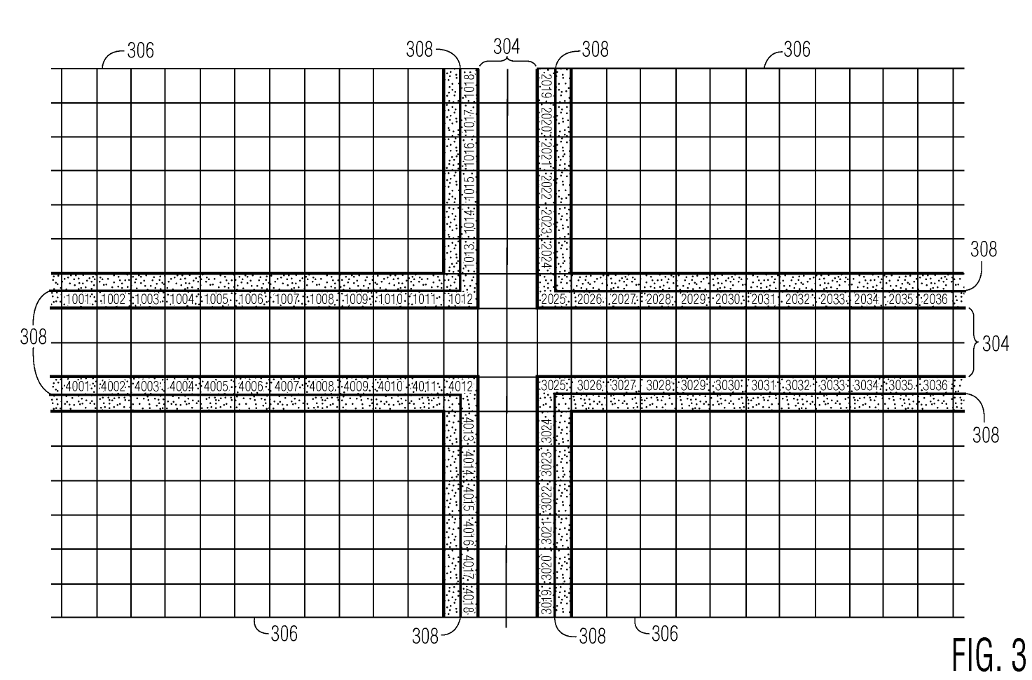

In an embodiment, agents located along each ruler in a department can be consecutively indexed (e.g., from 1 to 3000) and are referred to as “billets.” FIG. 3 illustrates billets 1001-1018, 2019-2036, 3019-3036, 4001-4018 in accordance with an embodiment of the invention. FIG. 3 illustrates a pathway 304 intersection and four wells 306 within a department. The sides of the pathways are lined with indexed billets along rulers 308. In an embodiment, rooms are placed within a building system along pathways so that the rooms can be accessed from the pathways (e.g., by a door or other opening). Rather than referring to each room as an array of agents, a room can be identified by the billet index corresponding to, for example, a corner of the room when placed. For example, the placement of a room spanning 6 agents in the X direction (e.g., 2 meters) and 6 agents in the Y direction (e.g., 2 meters) that is placed with the bottom left corner of the room on billet 1001 can simply be indicated by “1001,” the index number of the billet. In an embodiment, the corner of the room corresponding to the billet is relative to the room (e.g., the bottom left corner is always the corner to the right of the door when standing inside the room). In other embodiments, the billet can correspond to other corners of the room or to another position along the sides of the room. In another embodiment, a room may span 40 agents in the x-direction (e.g., and measure 4 meters) and may span 50 agents in the Y direction (e.g., and measure 5 meters).

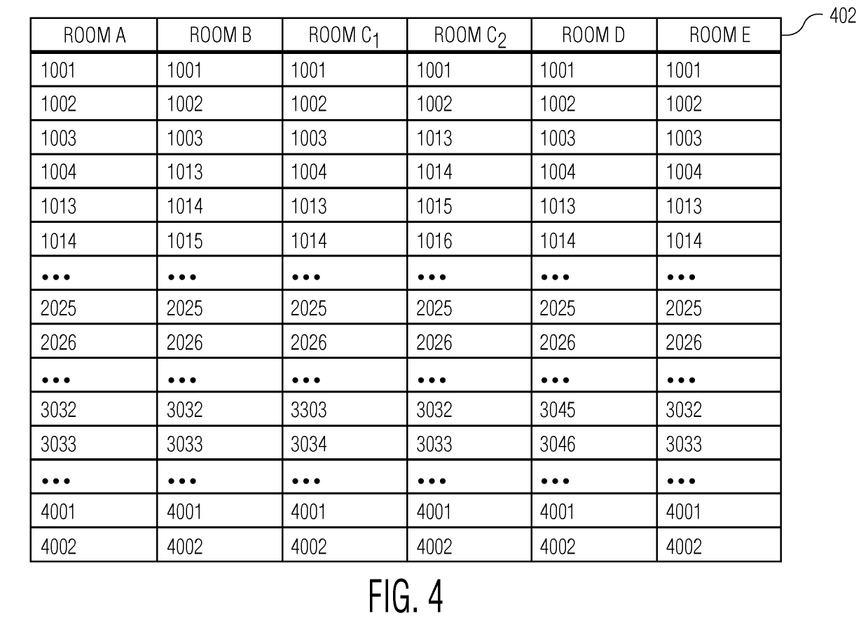

In an embodiment, each room is associated with a set of legal billets. FIG. 4 depicts a table 402 of legal billets for rooms to be placed in accordance with an embodiment of the invention. In an embodiment, legal billets are billets that correspond to agents along a ruler on which the bottom left corner of a room can be placed. For example, referring to FIG. 3, if a room spans 6 agents in the x-direction, then billet 1001 would be a legal billet for the room, while billet 1010 would be illegal because it does not have 5 or more agents to the right along the ruler. In FIG. 4, legal billets for six rooms are indicated: Room A, Room B, Room C₁, Room C₂, Room D, and Room E (each letter indicating a different room type). The order of the rooms in the table is independent of any placement or order in which the rooms might be placed in a room chromosome. In an embodiment, legal billets for each room can be determined manually by a user or can be determined automatically by a computer-implemented algorithm. For example, when determining a legal billet for a room, an “available( )” function can be called for each billet to automatically determine legal billets for a room. The available( )function takes each billet as input and, taking into account whether the room can overlap any structural components, the function determines all agents that would be occupied by the room relative to the billet, determines if any of the agents overlap structural components, and returns true (e.g., the billet is a legal billet) if a room can be placed on the billet (e.g., sufficient space remains on the ruler given the dimensions of the room and agents occupied by the room do not impermissibly overlap structural components if the bottom left corner of the room is placed on the billet) and records the billet in the table.

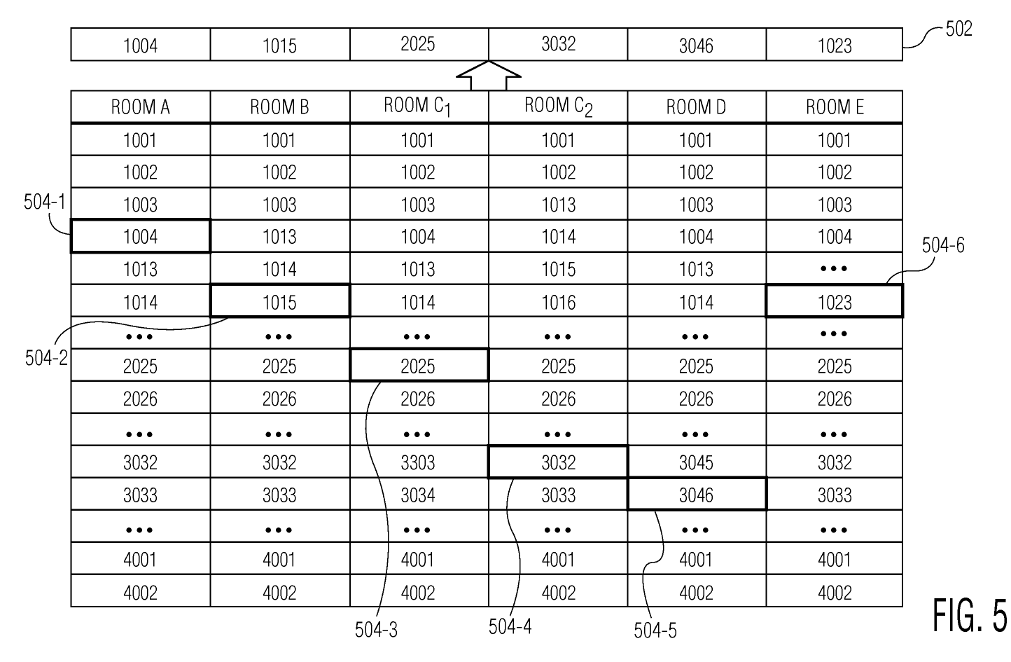

In an embodiment, initial room chromosomes can be generated by selecting an array of legal billets (e.g., one legal billet for each room to be placed as specified by a particular space program). FIG. 5 illustrates a room chromosome 502 for the placement of Room A, Room B, Room C₁, Room C₂, Room D and Room E within a department. In an embodiment, the room chromosome can be formed by selecting a legal billet 504-1-504-6 for each room (as indicated by the darkened borders) to form an array of legal billets (e.g., the room chromosome). The placement of each room is indicated by the corresponding legal billet. For example, in FIG. 5, the placement of Room A is indicated by billet 1004. To determine the full placement of Room A (e.g., to determine the full set of agents occupied by Room A) a “paint_room( )” function can be called. In an embodiment, the paint_room( )function takes a billet and returns the full set of agents that will be occupied by the room. For example, if Room A has an X-step of 10 and a Y-step of 16, then the paint_room( )function returns a set of agents that is 10-steps by 16-steps with the billet at the origin of the steps (e.g., bottom left).

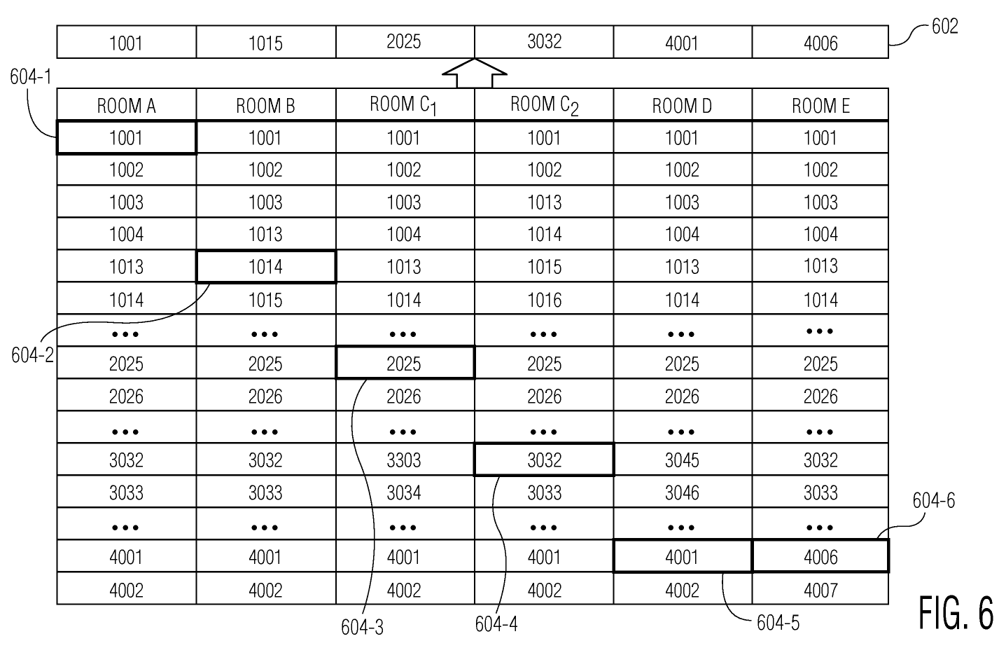

In an embodiment, a second room chromosome can be generated similarly to the room chromosome of FIG. 5. FIG. 6 illustrates a second room chromosome 602 for the placement of Room A, Room B, Room C₁, Room C₂, Room D and Room E within a department. The second room chromosome can be formed by selecting a legal billet (e.g., either different or the same as in FIG. 5) 604-1-604-5 for each room (as indicated by the darkened borders) to form an array of legal billets (e.g., the room chromosome for each room specified by a space program).

As described above, placing rooms in a building system involves generating a pool of room chromosomes and determining which one of the room chromosomes has a desired fitness value as calculated by a fitness function. In an embodiment, a desired fitness value can be the lowest fitness value for a room chromosome in the pool of room chromosomes. In other embodiments, the desired fitness value can fall within a range (e.g., a fitness value in the lowest 20% of fitness values calculated for room chromosomes in the pool) or any fitness value below a user-defined threshold (e.g., any fitness value below 5000). In order to calculate a fitness value, a fitness function is solved for each room chromosome. In an embodiment, the fitness function can be an integer function F(x) calculated by:

$$F ( x ) = {\sum }_{i < j} {C}_{ij} + {a}_{1} \sum {C}_{i} + {a}_{2} \sum {V}_{i} + {a}_{3} \sum {O}_{i} + {a}_{4} \sum {e}_{i}$$

where, i is a room position in a room chromosome, j is a room to be placed in the room chromosome, Cᵢⱼ is a constraint cost, Cᵢ is a cluster cost, Vᵢ is a violation cost, Oᵢ is an overlap cost, eᵢ is a capacity excess cost, and a₁, a₂, a₃, and a₄ are weights assigned to each cost. In an embodiment, a user can specify different constraints that apply to various rooms and the fitness function determines which costs to evaluate accordingly. For example, if a constraint requires a recovery room and an operating room to be placed in close proximity, then a constraint cost will need to be determined for each room chromosome. Alternatively, if no constraints require rooms to be placed in a certain proximity to each other, the constraint cost may not need to be determined by the fitness function. The fitness function adds the evaluated costs and returns the sum as an integer value. In an embodiment, the costs can be weighted differently as determined by a user. For example, overlap cost can be more heavily weighted in situations where overlap is undesirable.

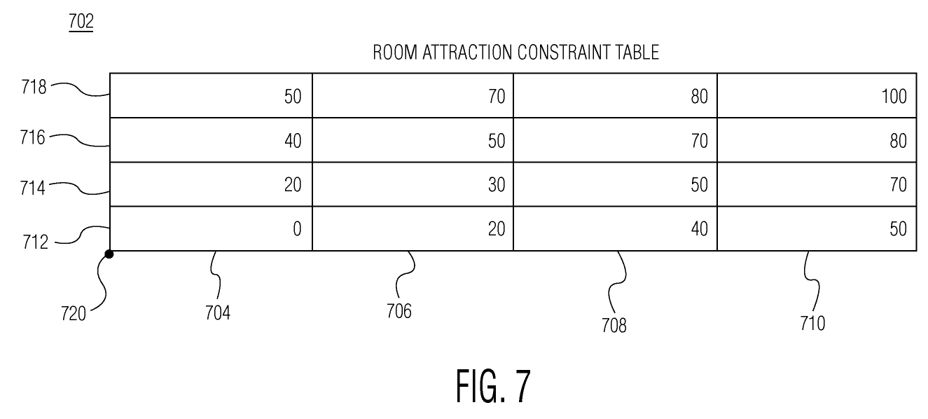

In an embodiment, the constraint cost depends on the relative distance between rooms within a department. FIG. 7 illustrates a constraint cost table 702 for an attraction constraint. In an embodiment, a department is broken up into four equal parts in the horizontal direction 704, 706, 708, 710 and vertical direction 712, 714, 716, 718 and each part corresponds to a cell in the constraint cost table. Constraint cost between two rooms can then be determined by placing the first room at the origin 720 and determining which of the 16 parts the second room is located in. For example, a room on the opposite side of a diagonal across a department would fall into part 16 (e.g., 4, 4) and would add a constraint cost of 100, as indicated by cell (4,4), to the fitness function value of the room chromosome, while a room on the same horizontal plane, but halfway across the department might fall into part 2 (e.g., 2,0) and would add a constraint cost of 40 to the fitness function value. In another embodiment, the table could be flipped to determine a constraint cost for a repulsion constraint. For example, a room placed on the opposite side of a diagonal across a department would add a constraint cost of zero to the fitness function. In an embodiment, many constraint cost tables can be populated (e.g., automatically or by a user) for each room within a department. For example, constraint cost tables can be populated for specific rooms (e.g., between operating room 1 and recovery room 1) or for general room types (e.g., between all operating rooms and recovery rooms). In other embodiments, constraint cost tables can be populated irregularly. For example, the constraint costs can increase by irregular intervals (e.g., the row along the x-axis can be populated with the values 0, 10, 12, and 50). In other embodiments, constraint costs can both increase and decrease across the table. For example, the row along the x-axis can be populated with the values 0, 12, 50, and 10. In other embodiments, constraint cost tables can be populated for other relationships and in other manners.

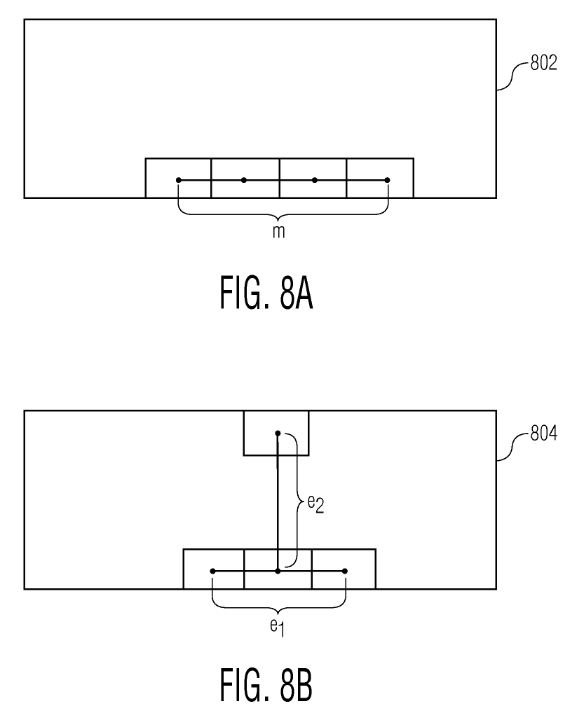

In an embodiment, the cluster cost depends on the proximity of rooms to each other. For example, a constraint may specify that at least three rooms should be placed near each nursing station. In an embodiment, the cluster cost is computed by evaluating a minimum spanning tree for all rooms in a cluster (e.g., a number of rooms equal to or less than the full set of rooms to be placed in a department). FIG. 8A illustrates a minimum spanning tree 802. The minimum spanning tree of FIG. 8A has the lowest possible value because the rooms are contiguous. FIG. 8B illustrates a second minimum spanning tree 804. The minimum spanning tree of FIG. 8B has a value calculated by

$$\frac{{e}_{1} + {e}_{2}}{m} - 1.0 .$$

Thus, because all me rooms in FIG. 8B are not contiguous (e.g., the values of e₁ and e₂ are greater than 0), the cluster cost of the configuration of FIG. 8A will be a lower cluster cost than the cluster cost of the configuration of FIG. 8B.

In an embodiment, the violation cost depends on the number of user-specified constraints violated in a room chromosome. A user-specified constraint can include, for example, minimum dimensions of a room, a minimum number of a room type to be included in a room chromosome, or proximity of a room to a stairwell or elevator.

In an embodiment, overlap cost depends on the number of agent overlaps in a given placement. For example, if a room is placed with an agent overlapping a structural column or on an agent already occupied by another room, the overlap cost of the placement will increase.

In an embodiment, capacity excess cost depends on the difference between the total sum of room sizes placed along a ruler and the capacity of the ruler. For example, if a ruler can accommodate 90 agents in the x-direction (e.g., the ruler has 90 billets), then placing a room covering 70 agents in the x-direction and a room covering 50 agents in the x-direction along the same ruler will result in a capacity excess cost of 30 (e.g., 70+50−90=30). In an embodiment, capacity excess cost is distinguishable from overlap cost. For example, if a ruler can accommodate 90 agents in the x-direction, then 3 rooms spanning 20 agents in the x-direction can be placed to fit overlapping within the ruler, which would increase the overlap cost, but, because it is possible to otherwise place the rooms to fit along the ruler without overlapping (despite not having done so), the capacity excess cost zero. Alternatively, 4 rooms spanning 20 agents in the x-direction could be placed to fit overlapping within the ruler, thus increasing the overlap cost, but could not possibly be placed to fit along the ruler without overlapping and, thus, the capacity excess cost would be greater than zero.

In an embodiment, an initial pool of room chromosome can be efficiently generated by applying a constraint-ratio heuristic to generate an initial number of room chromosomes (e.g., 200 room chromosomes or another number defined by a user). The constraint-ratio heuristic can consider constraints (e.g., the existence of structural components in a structural grid of a building) and ratios (e.g., space required by rooms compared to space available in a department, floor, or building) when placing rooms. In an embodiment, a constraint-ratio heuristic can select a legal billet for each room by determining a relative cost-resource index score, G[ij], for each legal billet and selecting the billet with the lowest cost-resource index score for each room. In an embodiment, a relative cost-resource index score is determined by the function G( ), which divides the width of the room to be placed by the remaining width of a ruler on which the room is to be placed. Thus, the fewer the number of rooms already placed along a ruler, the lower the cost-resource index score will be for a room.

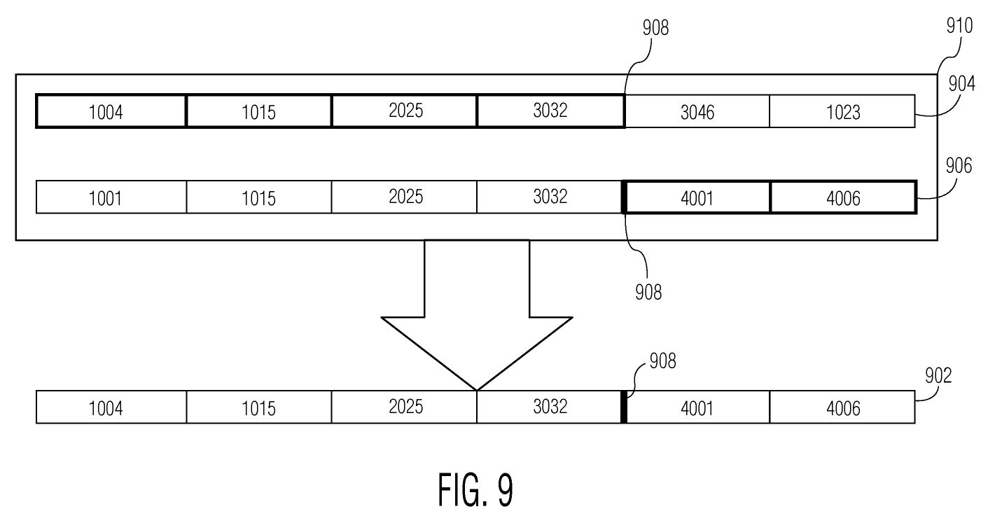

In an embodiment, several initial room chromosomes are generated and added to a pool of room chromosomes. Additional room chromosomes can then generated and added to the pool of room chromosomes by selecting two room chromosomes from the pool as parents for crossover using binary tournament selection, generating a new room chromosome using crossover, mutating the new room chromosome, and adding the new chromosome back to the pool of room chromosomes before generating another new room chromosome although other techniques can be used to populate a pool of room chromosomes (e.g., random generation). In an embodiment, binary tournament selection can be performed by selecting two room chromosomes from the pool at random. FIG. 9 illustrates the generation of a new room chromosome 902 using crossover in accordance with an embodiment of the invention. In other embodiments, other techniques can be used to apply crossover than are described below. The new room chromosome can be generated by combining a portion of billets before a break point 908 from a first room chromosome 904 in a pool 910 with a portion of billets after the break point from a second room chromosome 906 in the pool. In an embodiment, the break point can be placed at a random point along both room chromosomes (e.g., the same random point in both the first and second room chromosome). Thus, the new room chromosome may be more similar to a first parent room chromosome than to a second parent room chromosome if the break point comes late in the room chromosome.

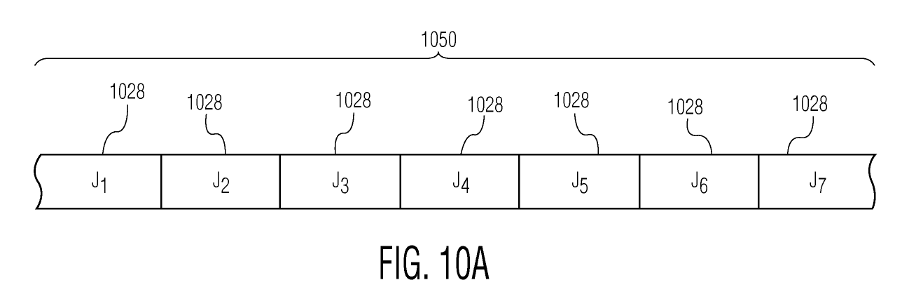

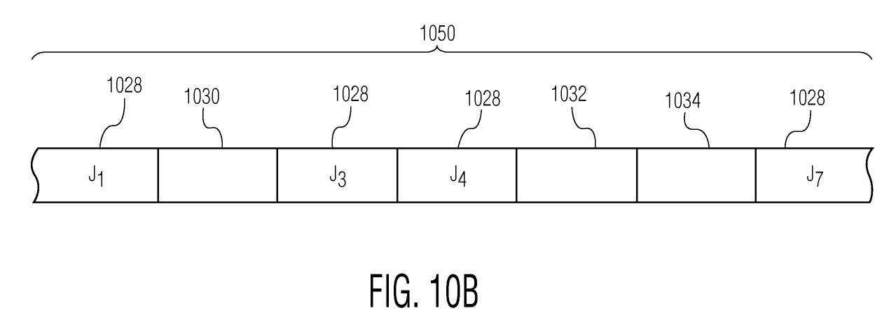

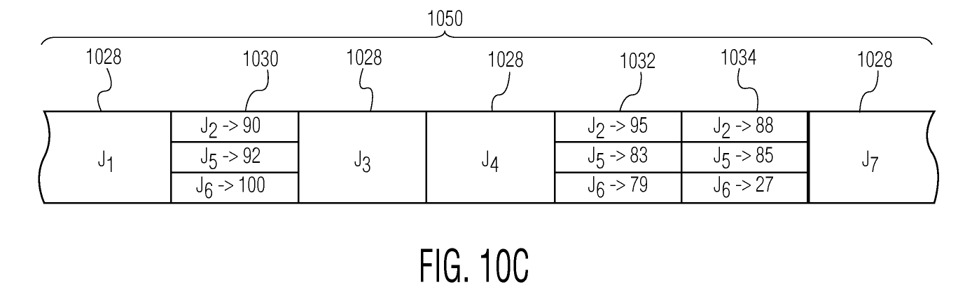

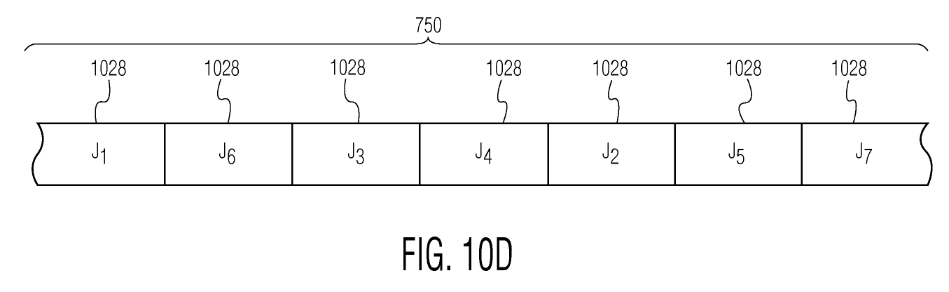

In an embodiment, new room chromosomes generated by crossover can be mutated using, for example, Martello and Toth's heuristic for mutation to swap placements of rooms within the new room chromosomes, but other techniques for mutating room chromosomes can be used as well. FIGS. 10A-10D illustrate the mutation process. FIG. 10A depicts a room chromosome 1050 of rooms 1028 to be placed in a floor plan. As depicted in FIGS. 10A-10D, rooms are identified by labels J₁-J₇ rather than Room A, Room B, Room C₁, Room C₂, Room D, and Room E, as described with respect to FIGS. 4-6 above, to highlight the relevance of order and position with respect to a room chromosome that is not relevant in the figures above. In an embodiment, the mutation process begins by releasing a number of rooms (e.g., two or three rooms) within a room chromosome. For example, as illustrated in FIG. 10B, rooms J₂, J₅, and J₆ are released from their locations 1030, 1032, 1034 by unassigning the rooms from their respective indexes in the array of a room chromosome. In an embodiment, a measure of desirability can be determined for the placement of each released room in each of the vacant locations. FIG. 10C illustrates the measure of desirability for the placement of each of the released rooms in each of the vacant locations. As illustrated, J₂ has desirability measures of 10 when placed in the first opening 1030, 5 when placed in the second opening 1032, and 28 when placed in the third opening 1034. J₅ has desirability measures of 12, 23, and 25, respectively, and J₆ has desirability measures of 0, 39, and 87, respectively. In an embodiment, the room with the greatest difference between its best measure of desirability (e.g., the value closest to zero) and its second best measure of desirability is placed in the location corresponding to its highest measure of desirability. FIG. 10D illustrates the placement of rooms J₂, J₅, and J₆. As illustrated, J₆ will be placed first because the difference between its best measure (0) and its second best measure (39) is greater than the difference for J₂ (5 and 10) and for J₅ (22 and 23). J₂ and J₅ are then placed such that the fitness value of the room chromosome is at its lowest. For example, since J₆ has been placed in the first opening, J₂ will be placed in the second opening (e.g., the opening with a better desirability measure for J₂ between the two remaining openings) and J₅ will be placed in the third opening (e.g., the opening with a better desirability measure for J₅ between the two remaining openings). In an embodiment, desirability is measured by calculating the value a placement would contribute to the overall fitness value of the room chromosome without recalculating the fitness value of the entire room chromosome. Recalculating the fitness value of the entire room chromosome is an operation of O(LN) difficulty, where N is the number of rooms in the room chromosome and L is the number of legal billets for each room. Alternatively, recalculating the fitness value for single room is an operation of O(L) difficulty, where L is the number of legal billets for the room. Thus, recalculating the fitness value for a single room rather than for the entire room chromosome is a much computationally simpler operation and can be performed with less computing resources. In an embodiment, rooms can only be swapped with rooms in the same zone. For example, if only 2 of 3 released rooms are in a first zone, the third room (e.g., the room not in the first zone) cannot be swapped with the first or second room.

In an embodiment, once a room chromosome has been mutated, the fitness value of the billet selected for each room in a room chromosome can be compared to the fitness value for every other legal billet of the room and, if a legal billet with a lower fitness value is found, the legal billet with the lower fitness value can be swapped in.

In an embodiment, crossover and mutation are repeatedly performed until the lowest fitness value calculated for a room chromosome in the pool remains unchanged over a user-defined number of iterations. For example, if a fitness value of 6024 is achieved by a room chromosome and after 100 subsequent crossovers and mutations the fitness value is still 6024, the room chromosome with the fitness value of 6024 can be selected.

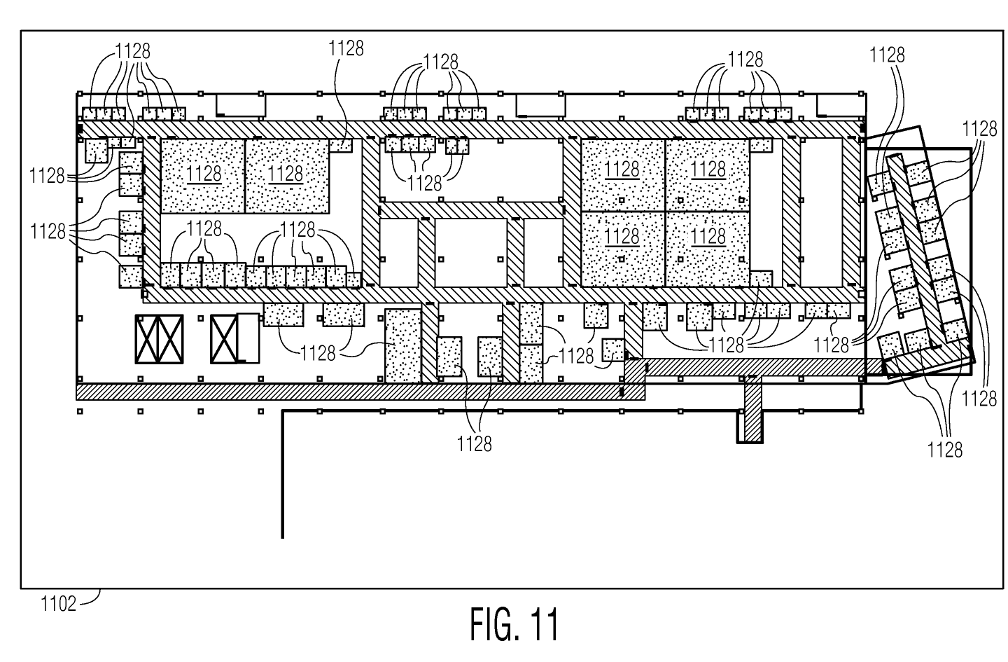

Once a room chromosome is selected, rooms can be placed in accordance with the room chromosome. FIG. 11 illustrates a placement of rooms 1128 within a floor plan 1102 of a hospital in accordance with a room chromosome. In an embodiment, rooms are placed in a floor plan by a software program (e.g., sketchup) such that the rooms are placed along internal corridors with room doors facing the corridor, as illustrated in FIG. 11.

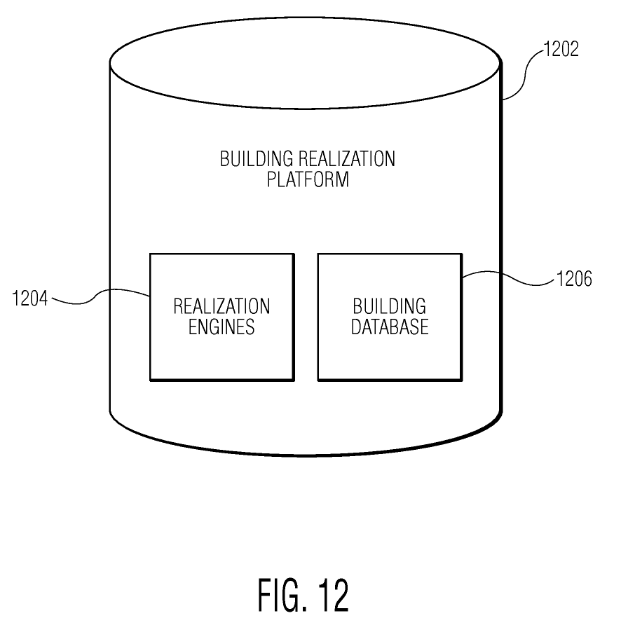

In an embodiment, the technique described above for placing rooms in a building system can be implemented using a building realization platform. FIG. 12 depicts a block diagram of a building realization platform (BRP) 1202. The BRP is supported by realization engines 1204 and a building database 1206. In an embodiment, the realization engines include the logic to drive the design, modeling, simulation, optimization, and verification operations related to a building system and the building database includes stored data related to the building system (virtual and/or real) that is designed, modeled, simulated, optimized, and verified by the realization engine. In an embodiment, a floor plan and a set of rooms to be placed within the floor plan (e.g., the space plan) is passed to the BRP and the BRP performs the above-described technique to return a room chromosome indicating a placement of rooms within the floor plan.

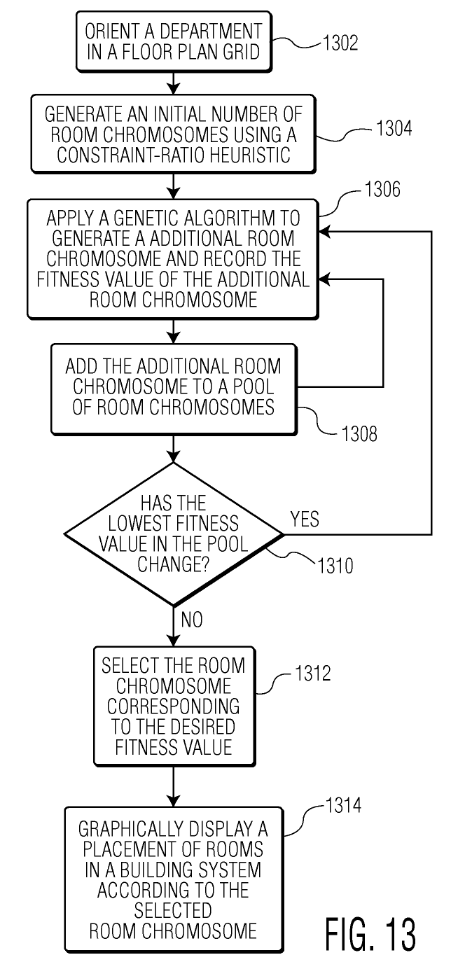

FIG. 13 is a flow chart diagram of a computer-implemented method for placing rooms in a building system in accordance with an embodiment of the invention. At block 1302, a department is oriented within a floor plan grid. In an embodiment, the department is oriented (e.g., by rotating, flipping, or other transformations) such that pathways are vertically or horizontally oriented in the floor plan grid as needed. At block 1304, an initial number of room chromosomes is generated using constraint-ratio heuristics. In an embodiment, the constraint-ratio heuristic considers constraints (e.g., the existence of structural components in a structural grid of a building) and ratios (e.g., space required by rooms compared to space available in a department, floor, or building) when placing rooms. At block 1306, a genetic algorithm is applied to the pool of room chromosomes to generate an additional room chromosome and the fitness value of the additional room chromosome is recorded. In an embodiment, applying the genetic algorithm can involve applying crossover and mutation heuristics. At block 1308, the additional room chromosome is added to the pool of room chromosomes. In an embodiment, the genetic algorithm is repeatedly applied for a user-defined number of iterations and each iteration generates a new room chromosome, which is added to the pool of room chromosomes. In an embodiment, the pool of room chromosomes can contain up to M room chromosomes and, if the pool of room chromosomes contains M room chromosomes when the additional room chromosomes is generated, the fitness value of the additional room is compared with the fitness value of the room chromosome in the pool with the highest fitness value and the room chromosome with the lower fitness value is kept or added to the pool and the room chromosome with the higher fitness value is removed from the pool or ignored. For example, if the highest fitness value of a room chromosome in the pool is 9524 and the fitness value of the additional room chromosome is 9928, then the additional room chromosome is ignored. Alternatively, if the fitness value of the additional room chromosome is 8792, then the additional room chromosome will be added to the pool and at least one room chromosome corresponding to the fitness value of 9524 will be deleted from the pool. At decision point 1310, after a number of additional room chromosomes have been added to the pool of room chromosomes, if the lowest fitness value in the pool of room chromosomes has changed (e.g., by the addition of the additional room chromosome to the pool), then the method returns to block 1306 and continues adding room chromosomes to the pool of room chromosomes. In an embodiment, the number of additional room chromosomes added to the pool of room chromosomes before the determination at decision point 1310 is made can be a user-defined number. For example, after 100 additional room chromosomes have been generated, the fitness values can be re-evaluated, but not after each additional room chromosome is generated. Alternatively, if the lowest fitness value in the pool of room chromosomes has not changed, then at block 1312, the room chromosome corresponding to the desired fitness value (e.g., the room chromosome with the lowest fitness in the pool or room chromosomes) is selected and, at block 1314, the placement of rooms in a building system is graphically displayed according to the selected room chromosome. For example, the placement of rooms in a building system, as shown in FIG. 11, is graphically displayed on a display device of a computer.

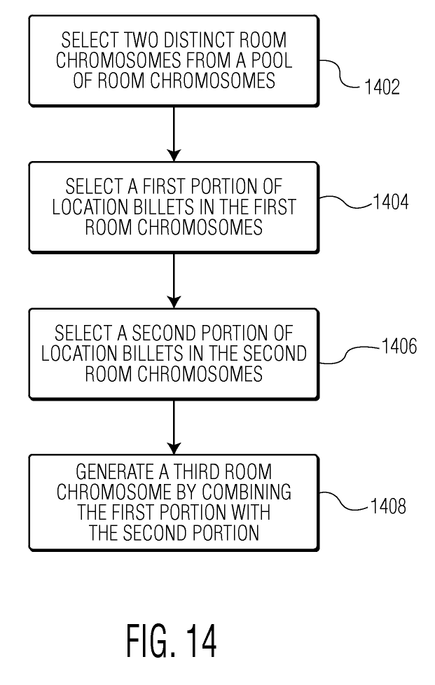

FIG. 14 is a flow chart diagram of a technique for applying crossover in accordance with an embodiment of the invention. At block 1402, two distinct room chromosomes are selected from a pool of room chromosomes. At block 1404, a first portion of billets in the first room chromosome is selected. In an embodiment, the first portion of billets includes billets for rooms 1-P, where P is the room before a break point, as described with reference to FIG. 9. At block 1406, a second portion of billets is selected from the second room chromosome. In an embodiment, the second portion of billets includes billets for room P+1−N, where N is the number of rooms in room chromosomes in the pool of room chromosomes. At block 1408, a third room chromosome is generated by combining the first portion of billets with the second portion of billets. In an embodiment, when combined, the first portion of billets and the second portion of billets include a billet corresponding to every room to be included in the room chromosome.

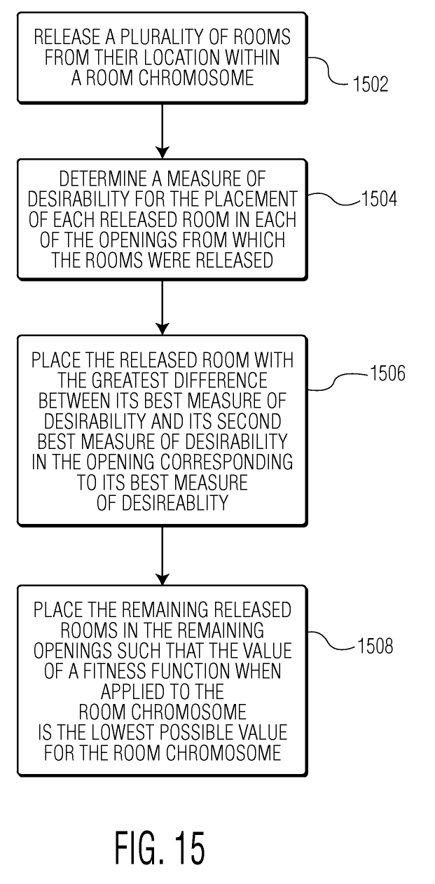

FIG. 15 is a flow chart diagram of a technique for applying mutation heuristics in accordance with an embodiment of the invention. At block 1502, a plurality of rooms are released from their location within a room chromosome. In an embodiment, two or three rooms are released. At block 1504, a measure of desirability is determined for the placement of each released room in each of the openings from which the rooms were released. At block 1506, the released room with the greatest difference between its best measure of desirability (e.g., closest to zero) and its second best measure of desirability is placed in the opening corresponding to its best measure of desirability. At block 1508, the remaining released rooms are placed in the remaining openings such that the value of a fitness function when applied to the room chromosomes is the lowest possible value for the room chromosome.

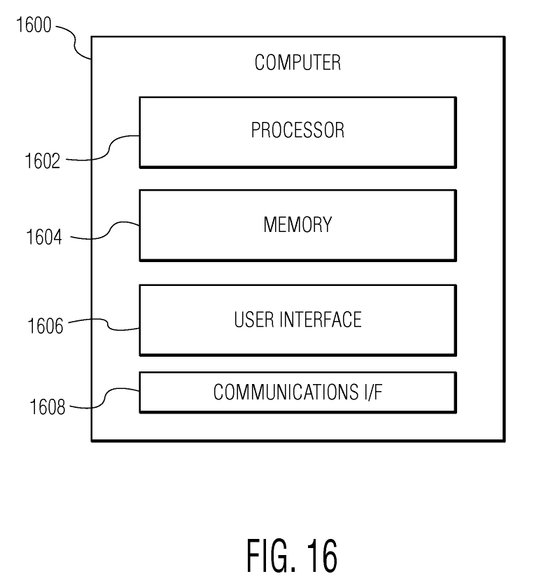

FIG. 16 is a block diagram of a computer 1600 in which the building realization platform can run. In an embodiment, the computer includes a processor 1602, memory 1604, a user interface 1606, and a communications interface 1608. In an embodiment, the processor executes instructions stored in the memory and, when the instruction are executed, the above-described techniques are performed. In an embodiment the user interface is a browser-based interface accessible to a user via interface devices (e.g., a display device) with browser capability. In an embodiment, the communications interface can be a standard I/O bus for communication with a keyboard and mouse or the communications interface can be a network interface card (NIC) configured to receive input over standard TCP/IP.

Thus, by describing a placement of rooms in a department as an array of legal billets, a room chromosome can be formed. A genetic algorithm can be applied to a pool of room chromosomes to alter and mutate the room chromosomes generating additional room chromosomes. In an embodiment, after a sufficient number of additional room chromosomes have been generated (e.g., as determined by user), a room chromosome with a desirable fitness value can be selected and a placement of rooms in a building system can be graphically displayed according to the selected room chromosome. By repeatedly mutating and altering the room chromosomes in the pool of room chromosomes, an optimized placement of rooms within a building can be determined.

Although the operations of the method(s) herein are shown and described in a particular order, the order of the operations of each method may be altered so that certain operations may be performed in an inverse order or so that certain operations may be performed, at least in part, concurrently with other operations. In another embodiment, instructions or sub-operations of distinct operations may be implemented in an intermittent and/or alternating manner.

It should also be noted that at least some of the operations for the methods may be implemented using software instructions stored on a computer useable storage medium for execution by a computer. As an example, an embodiment of a computer program product includes a computer useable storage medium to store a computer readable program that, when executed on a computer, causes the computer to perform operations, as described herein.

Furthermore, embodiments of at least portions of the invention can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device.

The computer-useable or computer-readable medium can be an electronic, magnetic, optical, electromagnetic, infrared, or semiconductor system (or apparatus or device), or a propagation medium. Examples of a computer-readable medium include a semiconductor or solid state memory, magnetic tape, a removable computer diskette, a random access memory (RAM), a read-only memory (ROM), a rigid magnetic disc, and an optical disc. Current examples of optical discs include a compact disc with read only memory (CD-ROM), a compact disc with read/write (CD-R/W), a digital video disc (DVD), and a Blu-ray disc.

In the above description, specific details of various embodiments are provided. However, some embodiments may be practiced with less than all of these specific details. In other instances, certain methods, procedures, components, structures, and/or functions are described in no more detail than to enable the various embodiments of the invention, for the sake of brevity and clarity.

Although specific embodiments of the invention have been described and illustrated, the invention is not to be limited to the specific forms or arrangements of parts so described and illustrated. The scope of the invention is to be defined by the claims appended hereto and their equivalents.

What is claimed is:

1. A computer-implemented method for placing rooms in a building system, the method comprising:
generating a pool of room chromosomes by applying a genetic algorithm, wherein a room chromosome corresponds to a placement of a set of rooms in a building system;
selecting a room chromosome with a desired fitness value from the pool of room chromosomes, the fitness value determined by applying a fitness function to at least one room chromosome in the pool; and
graphically displaying a placement of rooms in a building system according to the selected room chromosome.

2. The computer-implemented method of claim 1, wherein generating the pool of room chromosomes comprises:
generating an initial number of room chromosomes using a constraint-ratio heuristic
; and
adding additional room chromosomes to the pool of room chromosomes by:
generating an additional room chromosome by applying the genetic algorithm to the pool of room chromosomes; and
adding the generated additional room chromosome to the pool of room chromosomes.

3. The computer-implemented method of claim 1, wherein the desired fitness value is the lowest fitness value calculated by a fitness function for a room chromosome in the pool of room chromosomes.

4. The computer-implemented method of claim 2, wherein generating an initial room chromosome comprises forming an array of legal billets, each billet corresponding to a room to be placed in a department.

5. The computer-implemented method of claim 4, wherein legal billets are determined by:
orienting the department in a floor plan grid that is aligned with a structural grid of the building to divide the department into agents, the department indicating pathways, structural components, and boundaries;
indexing agents along the sides of pathways in the department to create billets;
for each room to be placed within the department, determining if a room can be placed on each billet; and
for each room, recording billets on which the room can be placed as legal billets.

6. The computer-implemented method of claim 5, wherein generating an initial room chromosome in a pool of room chromosomes comprises selecting a legal billet for each room to be placed within the department using a constraint-ratio heuristic function, the constraint-ratio heuristic function configured to take capacity constraints into account.

7. The computer-implemented method of claim 2, wherein applying the genetic algorithm to the pool of room chromosomes comprises applying crossover and mutation heuristics to generate additional room chromosomes.

8. The computer-implemented method of claim 2, wherein the genetic algorithm is repeatedly applied until a fitness value less than a user-defined value is calculated for a room chromosome in the pool of room chromosomes.

9. The computer-implemented method of claim 2, wherein the genetic algorithm is repeatedly applied a user-defined number of times.

10. The computer-implemented method of claim 7, wherein applying crossover comprises using binary tournament selection by:
randomly selecting two distinct parent room chromosomes from the pool of room chromosomes;
selecting a first portion of billets in the first parent room chromosome;
selecting a second portion of billets in the second parent room chromosome; and
generating a third room chromosome by combining the first portion with the second portion of billets;
wherein the combination of the first portion with the second portion includes billets for every room to be placed.

11. The computer-implemented method of claim 7, wherein applying mutation heuristics comprises applying the Martello-Toth heuristic for mutation to a room chromosome.

12. The computer-implemented method of claim 7, wherein applying mutation heuristics to a room chromosome comprises:
releasing a plurality of rooms from their location within a room chromosome;
determining a measure of desirability for the placement of each released room in each of the openings from which the rooms were released;
placing the released room with the greatest difference between its best measure of desirability and its second best measure of desirability in the opening corresponding to its best measure of desirability, wherein the closer a measure of desirability is to zero the better the measure is; and
placing the remaining released rooms in the remaining openings such that the fitness value of the room chromosome is the closest fitness value to the desired fitness value possible for the room chromosome.

13. The method of claim 12, wherein a measure of desirability is determined by calculating a value by which the placement would impact the fitness value for the room chromosome.

14. The computer-implemented method of claim 7, wherein the fitness function is an integer function evaluated for several components, the components comprising:
a constraint cost;
a cluster cost;
a violation cost;
an overlap cost; and
a capacity excess cost.

15. The method of claim 14, wherein the fitness function F(x) for j rooms is calculated by:
$$F ( x ) = {\sum }_{i < j} {C}_{ij} + {a}_{1} \sum {C}_{i} + {a}_{2} \sum {V}_{i} + {a}_{3} \sum {O}_{i} + {a}_{4} \sum {e}_{i}$$
wherein i is a billet index, Cᵢⱼ is the constraint cost, Cᵢ is the cluster cost, Vᵢ is the violation cost, Oᵢ is the overlap cost, eᵢ is the capacity excess cost, and a is the weight for each cost.

16. The computer-implemented method of claim 14, wherein the constraint cost is determined by the relative distance between rooms within a department.

17. The computer-implemented method of claim 14, wherein the cluster cost is determined by the proximity of rooms to each other.

18. The computer-implemented method of claim 14, wherein the violation cost is determined by the number of user-defined constraints violated by a room chromosome.

19. The computer-implemented method of claim 14, wherein the overlap cost is determined by the number of agent overlaps in a room chromosome.

20. The computer-implemented method of claim 14, wherein the capacity excess cost is determined by the difference between the total sum of room sizes placed along a ruler and the capacity of the ruler.

21. The computer-implemented method of claim 14, wherein the constraint cost is determined by the relative distance between rooms within a department, the cluster cost is determined by the proximity of rooms to each other, the violation cost is determined by the number of user-defined constraints violated by a room chromosome, the overlap cost is determined by the number of agent overlaps in a room chromosome, and the capacity excess cost is determined by the difference between the total sum of room sizes placed along a ruler and the capacity of the ruler.

22. A computer-implemented method for placing rooms in a building system, the method comprising:
generating a pool of room chromosomes by:
generating an initial number of room chromosomes using a constraint-ratio heuristic
; and
adding additional room chromosomes to the pool of room chromosomes by:
generating an additional room chromosome by applying a genetic algorithm to the pool of room chromosomes by applying crossover and mutation heuristics; and
adding the generated additional room chromosome to the pool of room chromosomes; and
selecting a room chromosome with a desired fitness value from the pool of room chromosomes, the fitness value determined by applying a fitness function to at least one room chromosome in the pool; and
graphically displaying a placement of rooms in a building system according to the selected room chromosome.
